(19) United States
(12) Patent Application Publication
(10) Pub. No.: US 2025/0328638 A1
(43) Pub. Date: Oct. 23, 2025

(54) Automated Detection and Management System for Unauthorized External Service Accounts Using Large Language Models and Email Analysis

(71) Applicant: Waldo Security, LLC, Morgan Hill, CA (US)

(72) Inventor: Julian Weinberger, Morgan Hill, CA (US)

(21) Appl. No.: 19/170,825

(22) Filed: Apr. 4, 2025

Related U.S. Application Data
(60) Provisional application No. 63/636,528, filed on Apr. 19, 2024.

(51) Int. Cl. G06F 21/55

(52) U.S. Cl. CPC G06F 21/554; G06F 2221/034

(57) ABSTRACT

The present invention is a system and method to help with resolving the pervasive issue of unauthorized external service accounts and subscriptions created by employees within an organization. The present invention seeks to provide users with a system that strategically analyzes organizational email communications, which serve as a rich data source for identifying unauthorized external accounts and services. The system accesses each email account under an organizational domain, wherein each email is cleared of unnecessary content. Additionally, an LLM analysis performs various cross checks, and an AI integrity check verifies all LLM responses. Finally, the system and method documents and report all findings to the organization.

### FIELD OF THE INVENTION

The present invention relates generally to a system for automatically detecting unauthorized external service accounts. More specifically, the present invention is a system that accesses emails and analyses the contents within to detect unauthorized external service accounts.

### BACKGROUND OF THE INVENTION

In the contemporary landscape of cybersecurity, safeguarding organizational assets and resources is paramount. With the evolution of IT infrastructure, resources are increasingly dispersed, not just within the organization's internal network but also across various third-party providers accessible via the internet. This decentralization presents a significant challenge in the form of Shadow IT, where employees, in an effort to enhance their productivity, independently sign up for external services such as monday.com, salesforce.com, docker.com, and others without organizational approval or oversight.

This practice, while seemingly benign in the pursuit of efficiency, introduces substantial security vulnerabilities. Organizations find themselves inadvertently exposed to risks due to the lack of visibility and control over these unsanctioned accounts and services. Key issues include Unauthorized Data Exposure, Persistent Access Post-Employment, and Lack of Oversight and Control. For unauthorized data exposure employees may sign up for services that are not vetted by the organization, leading to potential exposure of sensitive information, including but not limited to code repositories, account details, and proprietary documents. For persistent access post-employment when employees leave the organization, the accounts and services they have activated remain accessible, posing a lingering risk of unauthorized access and data breaches. For lack of oversight and control the organization's inability to monitor these external services results in a significant blind spot in its cybersecurity posture. Without knowledge of where its data resides or how it's being used, the organization cannot effectively enforce its security policies or comply with regulatory requirements.

An objective of the present invention is to provide users with a system and method for the automated discovery, inventory, and management of unsanctioned third-party services and accounts associated with the organization. The present invention intends to provide users comprehensive visibility into all external services accessed under the organization's domain, irrespective of the official sanction status, thereby enabling proactive security management, policy enforcement, and the mitigation of associated risks. In order to accomplish that, a preferred embodiment of the present invention comprises an initial filtering stage, a pre-processing stage, a Large Language Model (LLM 13) analysis, an AI integrity check, and a logging stage. Further, through the present invention, organizations will be empowered to regain control over their digital footprint across third-party platforms, ensuring data security, compliance, and the integrity of their IT infrastructure. Thus, the present invention is an automatic detection and management system for unauthorized external service accounts using LLM 13 and email analysis

### BRIEF DESCRIPTION OF THE DRAWINGS

FIG. 1 is an illustration of the present invention.

FIG. 2 is a block diagram of the system of the present invention.

FIG. 3 is a flowchart view of the present invention.

FIG. 4 is a block diagram of the system of the present invention.

### DETAILED DESCRIPTION OF THE INVENTION

All illustrations of the drawings are for the purpose of describing selected versions of the present invention and are not intended to limit the scope of the present invention.

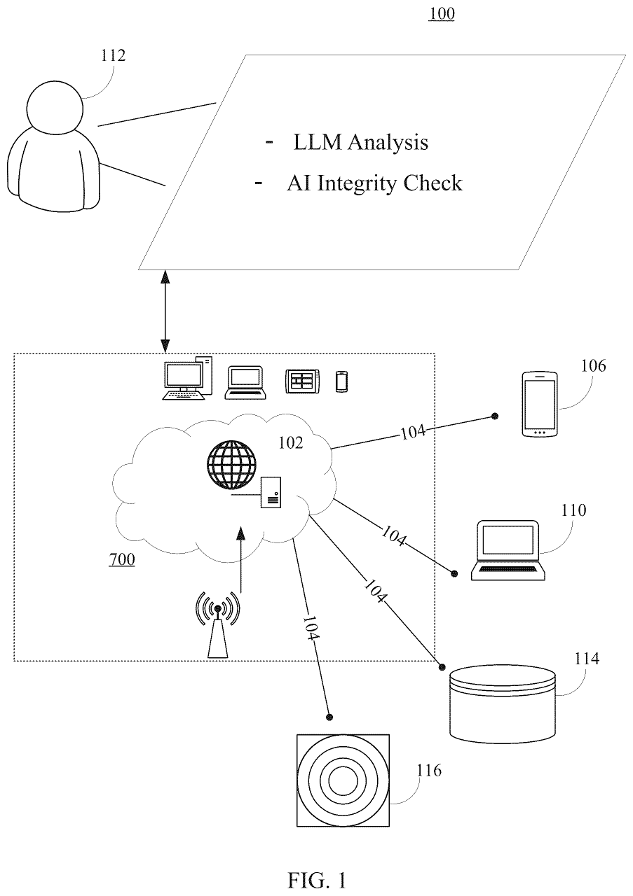

FIG. 1 is an illustration of an online platform 100 consistent with various embodiments of the present disclosure. By way of non-limiting example, the online platform 100 to enable facilitating management of employee data may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on.

Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

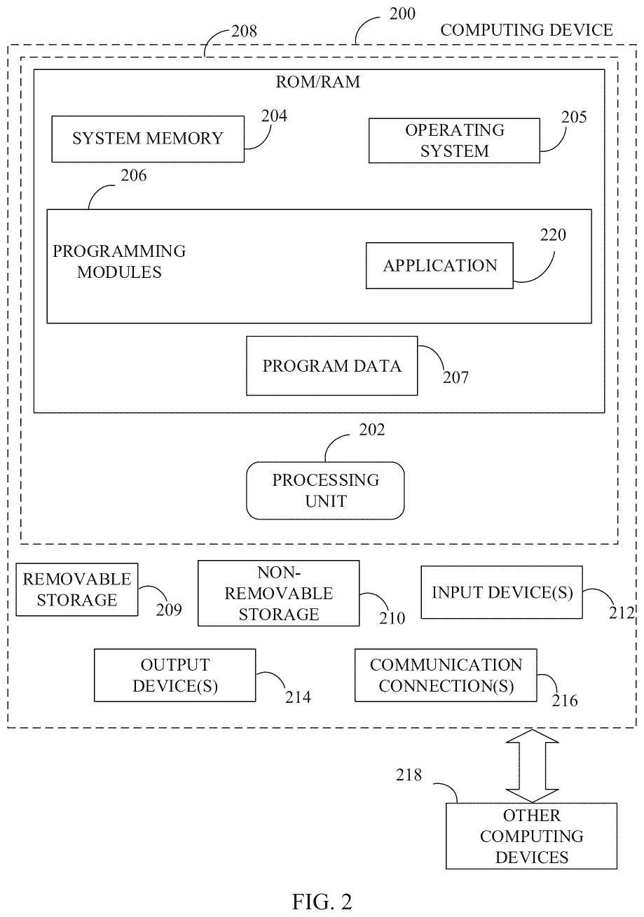

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications

As can be seen in FIG. 1 through FIG. 4, the preferred embodiment of the present invention is a method that utilizes large language models (LLM 13) for nuanced analysis of email content from external services. The method of the present invention utilizes LLMs 13 to understand text and contextual awareness, to identify the nature of an email and differentiate between an email signifying an actual service subscription and one that is merely promotional. The present invention intends to provide users with a system that reduces the rate of false positives, enhancing the efficacy of the detection process. The present invention employes a workflow to identify unauthorized external service accounts and subscriptions through the analysis of corporate email communications. This design enables the LLMs 13 to be leveraged for core analysis, while incorporating several preparatory and post-analysis steps to ensure efficiency and accuracy. For example, if a user receives a promotional email from an email external to an organization, the incoming email 3 is then cleared of unnecessary text such as links and images, reduced in size by text characters and submitted to an LLM 13 for processing. In this way, the method of the present invention is an automatic detection and management method for unauthorized external service accounts using LLM 13 and email analysis.

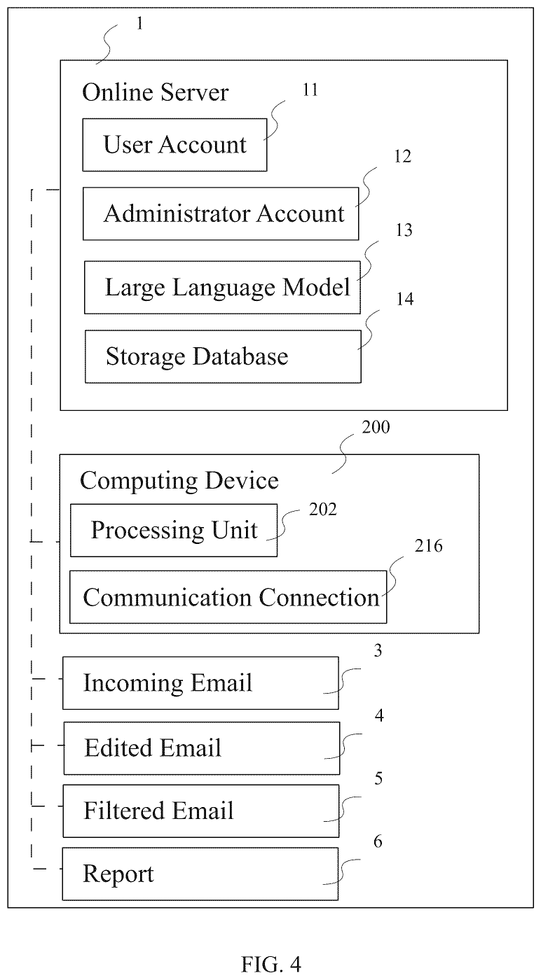

FIG. 4, illustrates a block diagram of a system for detecting and managing unauthorized external service accounts using large language models and email analysis, in accordance with some embodiments. Accordingly, the system may include an online server 1, a computing device 200, at least one incoming email 3, at least one edited email 4, at least one filtered email 5, at least one report 6. Further the online server 1 may further comprise a user account 11, an administrator account 12, a large language model, and a storage database 14. Furthermore, the computing device 200 may comprise a processing unit 202 and a communication connection 216. The communication connection 216 is configured for remote communication with the online server 1. This design enables the computing device 200 to receive and send data to the online server 1. Further the user account 11 may be configured to provide at least one incoming email 3. The user account 11 is associated with an email account within an organization that receives emails. The emails are then accessed by the user account 11 wherein at least one incoming email 3 may be analyzed by the system and method. Further, the administrator account 12 may be configured for receiving at least one report 6 from the online server 1. Once at least one incoming email 3 is processed and flagged for being from an outside external source, the at least one email information is logged and sent to an administrator within a report 6.

Further, each edited email 4 may be associated with each incoming email 3 provided by the user account 11. Each edited email 4 is associated with one incoming email 3. Once an incoming email 3 is received by the online server 1, unnecessary text, images, and links are removed, wherein the incoming email 3 becomes and edited email 4. Further, the filtered email 5 may be associated with each edited email 4 processed by the online server 1. Each filtered email 5 is associated with one edited email 4. Once an edited email 4 is formed, the edited email 4 is processed by the online server 1, reducing the number of words within the edited email 4, with the final text output resulting in a filtered email 5. Each filtered email 5 is at least 30% to 70% shorter in text length compared to each associated edited email 4. The back end of the text of the edited email 4 is removed to form a filtered email 5, leaving the beginning text portion. Each edited email 4 is processed if the edited email 4 contains less than 700 words. Furthermore, the user account 11 may be configured for providing at least one incoming email 3. This enables the online server 1 access to emails within an organization to detect unauthorized emails. Further, the online server 1 may be configured for removing unnecessary content form the at least one incoming email 3. This ensures that the resulting email that is being processed only contains relevant information and text. Further, the online server 1 may be configured for filtering at least one edited email 4 based on word count. If the word count of an edited email 4 is too large the edited email 4 is disregarded. If the word count of an edited email 4 is below the range of 150 to 300 words, the edited email 4 is directly submitted to the LLM 13. Further, the online server 1 may be configured for filtering the text length of at least one edited email 4. If the word count of an edited email 4 is within a target range of 150 and up to 700 words, the edited email 4 is filtered and anywhere from 30% to 70% of the words are removed, resulting in a filtered email 5. Further, the online server 1 may be configured for submitting at least one filtered email 5 to the large language model. The filtered email 5 is then analyzed based on content and context to determine if the original incoming email 3 was from an unauthorized external source. Further, the online server 1 may be configured for compiling findings from the at least one filtered email 5 being processed. When an unauthorized email is found, the information is logged and recorded. Further, the online server 1 may be configured for sending at least one report 6 to the administrator account 12.

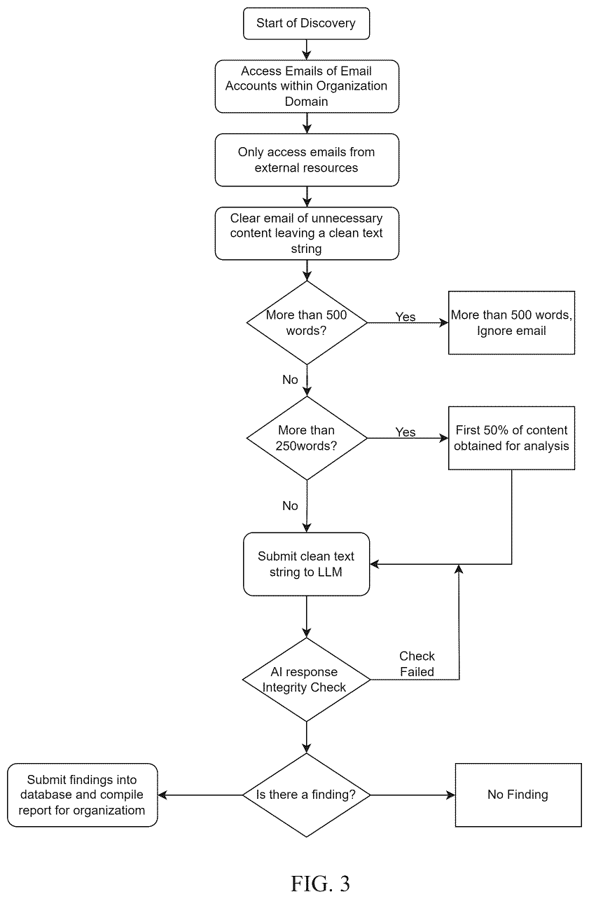

As can be seen in FIG. 3, the system used to execute the method of the present invention allows the present invention to function as a filtering system, reducing the size and content of at least one incoming email 3. To accomplish this, the method of the present invention comprises an initial filtering stage. The initial filtering stage is initiated on an hourly interval to discover new services and accounts. In its preferred embodiment the initial filtering stage comprises processes for accessing email accounts and filtering external emails. The process for accessing email accounts is initiated by the system by accessing individual user accounts 11 through the API of the email provider. The email provider being but not limited to Microsoft 365, Gmail, Yahoo, AOL, etc. This design ensures real time analysis of all incoming emails 3 under the organizational domain. The filtering external emails process begins by only focusing on emails sent from external accounts outside of the organizational domain. This design reduces the volume of emails and focuses the process on potential external service sign-ups, excluding internal communications. It should be further noted that the initial filtering stage can be executed in various ways providing the system access to email accounts through various means while still staying within the scope of the present invention. The system used to execute the method of the present invention comprises a pre-processing stage. The pre-processing stage executes after the initial filtering stage is completed. The pre-processing stage in its preferred embodiment comprises processes for clearing email content and word count filters. The process for clearing email content begins with the system receiving at least one incoming email 3 in an HTML format. The incoming email 3 is then converted to a text format and is stripped of non-essential elements to facilitate the LLM 13 analysis. Links, images, formatting, signatures, addresses, emojis, and other non-textual elements are removed, resulting in a clean text string. The word count process utilizes a word threshold. The clean text string is analyzed, and if it contains more than a selected number of words, the email is discarded and excluded. This is due to most emails over 300 words being associated with newsletters, updates, or marketing material. If the email is between 700 words and 150 words only the first 30% to 70% of words within the clean text string are retained. This new shortened text string is then submitted to the LLM 13 analysis in the subsequent stage. If the email is under 250 words, the clean text string is directly submitted to the LLM 13 analysis in the subsequent stage. This design optimizes the balance between thoroughness and processing efficiency.

As can be seen in FIG. 3, the system used to execute the method of the present invention allows the present invention to identify unauthorized emails unrelated to the organization such as promotional or spam emails. To accomplish this, the method of the present invention comprises an LLM 13 analysis stage. The LLM 13 analysis begins once a clean text string is sent from the pre-processing stage. In its preferred embodiment the LLM 13 analysis comprises processes for submitting the clean text string to the LLM 13 and for cross-referencing services. Once a clean text string is received it is submitted to the LLM 13. The preprocessed email text is submitted to an LLM 13 for analysis. The model assesses the content to identify indicators of new service sign-ups, account names, and service validity, while differentiating from newsletters and non-service-related communications. The cross-referencing service process utilizes the LLM 13. The LLM 13 leverages an extensive dataset to cross-reference the detected services against known services, ensuring high accuracy and reducing false positives. The system used to execute the method of the present invention comprises an AI integrity check. The AI integrity check begins once the LLM 13 analysis is completed. The AI integrity check is designed to verify the LLM 13 responses. Once the LLM 13 analysis output is received, the system performs an integrity check to verify the logical consistency of the responses. The AI integrity check is necessary to identify any “hallucinations” or inaccuracies in the LLM 13 analysis. In the event that an inconsistency or error is detected, the clean text string is sent back to the LLM 13 analysis to be reanalyzed until a coherent logical response is obtained.

As can be seen in FIG. 4, the system used to execute the method of the present invention allows the present invention to function as a reporting system, wherein a user account's 11 incoming emails 3 are compiled and reported to an administrator account 12 if at least one of the incoming emails 3 is an unauthorized email. To accomplish this, the method of the present invention comprises a logging stage. The logging stage begins once the AI integrity check is completed without any errors. The logging stages is designed to provide a user interface report 6 and log each database entry. In its preferred embodiment the logging stage comprises processes for documenting and reporting. The documenting process logs all relevant information into a database if the LLM 13 analysis identifies a new service or account sign-up. This ensures all detected accounts and services are cataloged for further action. The reporting process goes through the database to compile each of the cataloged accounts and services. The findings are then presented to the organization through a user interface, allowing for convenient review and management or unauthorized external services and accounts. Furthermore, the reporting process sends out emails and notifications on a schedule determined by the organization to regularly update the organization on unauthorized accounts and services. The user interface that provides the report 6 for the organization is accessible through any standard web interface, allowing for remote access to the report 6 for the organization.

In the pursuit of enhancing cybersecurity measures and safeguarding sensitive information, the present invention employs rigorous data security and privacy protocols. A paramount feature of the present invention is the commitment to ensuring that data processed by the Large Language Models (LLMs 13) is exclusively used for the analysis and identification of unauthorized external service accounts and subscriptions. It is crucial to underscore that this data is not utilized to refine or augment the machine learning algorithms or the artificial intelligence framework underlying the discovery tool. This approach guarantees that the information remains strictly confined to its intended purpose, thereby mitigating any potential misuse or unauthorized access. To further bolster data integrity and confidentiality, all information captured and stored within the system is allocated to tenant-specific databases. This architecture ensures absolute segregation of data across different tenants of the platform, eliminating the risk of cross-tenant data exposure. The databases are engineered to enable solely the customer to access their data, providing an additional layer of security and control. Moreover, recognizing the diverse needs and security postures of clients, the system offers the capability for data within the database to be encrypted using customer-hosted encryption keys. This feature affords organizations the flexibility to apply their encryption standards and protocols, thereby enhancing the overall security of the stored data. Through these measures, the present invention not only assures the confidentiality and integrity of the information but also aligns with the highest standards of data protection and privacy regulations.

Understanding the dynamic and interconnected landscape of cybersecurity operations, the present invention is designed to seamlessly integrate with existing ticketing systems. This integration capability facilitates the automatic creation of tickets for incidents identified through the present invention, such as the discovery of unsanctioned services or accounts. For instance, if a new service is detected and it has not been previously approved by the organization, a ticket is automatically generated to alert the security team. This process ensures that potential security threats are promptly communicated and addressed, enabling the security team to take necessary actions without delay. The integration of ticketing systems underscores the present inventions capability of being easily adaptable and its role as a vital component of an organization's cybersecurity framework. By automating the notification and incident management process, it alleviates the need for additional staffing or resources dedicated to monitoring and managing these risks. Consequently, the present invention empowers security teams to efficiently manage their operations, allowing them to focus on strategic security initiatives rather than the manual tracking of unsanctioned external services and accounts. This integration not only enhances operational efficiency but also significantly contributes to strengthening the organization's overall security posture. With all the components working in tandem with each other it can be seen that, the present invention is an automatic detection and management system for unauthorized external service accounts using LLM 13 and email analysis.

In reference to FIG. 3, a sub-process of the method of the present invention enables the system to filter incoming emails 3. To that end, the sub-process begins by filters at least one incoming email 3 based on email domains. When the incoming email 3 has an email domain that is used by a desired organization the incoming email 3 is ignored. However, if the incoming email 3 does not have an email domain associated with the organization the incoming email 3 is processed.

In reference to FIG. 3, a sub-process of the method of the present invention enables emails to be sorted based on text length. To that end, the sub-process begins by processing at least one edited email 4 if the text length of the edited email 4 is less than 700 words. Therefore, if the edited email 4 is over 700 words the email is ignored and categorized as an authorized email. The value for the text length may be adjusted and may range anywhere from 300 to 700 words wherein 700 words is the preferred cutoff value. In reference to FIG. 3, a sub-process of the method of the present invention enables edited emails 4 to be reduced in text length before being submitted to the LLM 13. To that end, the sub-process begins by filtering at least one edited email 4 if the text length of the edited email 4 is more than 150 words. Therefore, if an edited email 4 is over 150 words the edited email 4 is reduced in text length and becomes a filtered email 5. The value for the text length may be adjusted and may range anywhere from 150 to 300 words. The sub-process continues by reducing the text length of at least one edited email 4 by at least 30% to 70%. This enables the edited email 4 with a text length above 150 and below 700 words to be reduced in text length. The online server 1 removes the last 30% to 70% of the text length of the edited email 4, wherein the shortened edited email 4 becomes a filtered email 5.

In reference to FIG. 3, a sub-process of the method of the present invention enables edited emails 4 to bypass the filtering process depending on the text length of the edited email 4. To that end, the sub-process begins by sending at least one edited email 4 to the large language model without reducing the text length if the text length is below 150 words. Therefore, if an edited email 4 is less than 150 words in length, the edited email 4 automatically becomes a filtered email 5 and is sent directly to the LLM 13 without a reduction in text length.

In reference to FIG. 3, a sub-process of the method of the present invention enables the system to check results from the LLM 13. To that end, the sub-process begins by resubmitting at least one filtered email 5 to the large language model if the artificial intelligence check fails. If artificial intelligence has detected an inconsistency or irregularity in the response from the LLM 13 the filtered email 5 is reprocessed by the LLM 13.

In reference to FIG. 3, a sub-process of the method of the present invention enables reports 6 to be created and sent to an administrator outlining the number and details of unauthorized emails being sent to a user account 11. To that end, the sub-process begins by analyzing at least one filtered email 5 with respect to the large language model. The LLM 13 determines if a filtered email 5 is from an unauthorized external source or from an authorized external source. The sub-process continues by storing the findings processed by the large language model within the online server 1. Thus, the information about the unauthorized emails is aggregated within the storage database 14. The sub-process continues by accessing the findings within the report 6 generated by the online server 1. Thus, the online server 1 may send the report 6 to an administrator account 12, wherein a breakdown of the unauthorized emails may be visualized and accessed.

Although the invention has been explained in relation to its preferred embodiment, it is to be understood that many other possible modifications and variations can be made without departing from the spirit and scope of the invention as hereinafter claimed.

What is claimed is:

1. A system for detecting and managing unauthorized external service accounts using large language models and email analysis comprising:
an online server;
a computing device;
at least one incoming email;
at least one edited email;
at least one filtered email;
at least one report;
the online server comprising a user account, an administrator account, a large language model, and a storage database;
the computing device comprising a processing device and a communication module;
the communication module being in remote communication with the online server;
the user account providing at least one incoming email; and
the administrator account receiving at least one report from the online server.

2. The system for detecting and managing unauthorized external service accounts using large language models and email analysis as claimed in claim 1 comprising:
each edited email being associated with each incoming email provided by the user account;
each filtered email being associated with each edited email processed by the online server; and
each filtered email being at least 30% to 70% shorter in text length compared to each associated edited email.

3. The system for detecting and managing unauthorized external service accounts using large language models and email analysis as claimed in claim 1 wherein each edited email being processed if containing less than 700 words.

4. A method for detecting and managing unauthorized external service accounts using large language models and email analysis comprising:
providing, using a user account, at least one incoming email;
removing, using an online server, unnecessary content from the at least one incoming email;
filtering, using the online server, at least one edited email based on word count;
filtering, using the online server, the text length of the at least one edited email;
submitting, using the online server, at least one filtered email to the large language model;
compiling, using the online server, findings from the at least one filtered email being processed; and
sending, using the online server, at least one report to the administrator account.

5. The method for detecting and managing unauthorized external service accounts using large language models and email analysis as claimed in claim 4 comprising filtering, using the online sever, at least one incoming email based on email domains.

6. The method for detecting and managing unauthorized external service accounts using large language models and email analysis as claimed in claim 4 comprising processing, using the online server, at least one edited email if the text length of the edited email is less than 700 words.

7. The method for detecting and managing unauthorized external service accounts using large language models and email analysis as claimed in claim 6 comprising filtering, using the online server, at least one edited email if the text length of the edited email is more than 150 words.

8. The method for detecting and managing unauthorized external service accounts using large language models and email analysis as claimed in claim 7 comprising reducing, using the online server, the text length of at least one edited email by at least 30% to 70%.

9. The method for detecting and managing unauthorized external service accounts using large language models and email analysis as claimed in claim 7 comprising sending, using the online server, at least one edited email to the large language model without reducing the text length if the text length is below 150 words.

10. The method for detecting and managing unauthorized external service accounts using large language models and email analysis as claimed in claim 4 comprising resubmitting, using the online server, at least one filtered email to the large language model if the artificial intelligence check fails.

11. The method for detecting and managing unauthorized external service accounts using large language models and email analysis as claimed in claim 4 comprising:
analyzing, using the online server, at least one filtered email with respect to the large language model;
storing, using a storage database, the findings processed by the large language model within the online server; and
accessing, using the storage database, the findings within the report generated by the online server.
